(19) United States
(12) Patent Application Publication
(10) Pub. No.: US 2018/0374364 A1
(43) Pub. Date: Dec. 27, 2018

(54) VISUALIZATION: ICON, COLOR CODING AND HISTORICAL ROUTING INFORMATION FOR IoT DEVICES

(71) Applicant: Aeris Communications, Inc., San Jose, CA (US)

(72) Inventors: Ryan David Kennedy, Naperville, IL (US); Hector Aquiles Rodriguez, Chicago, IL (US); Van Hoang Thuy Nguyen, San Jose, CA (US); Gurinder Singh Dhilllon, Sunnyvale, CA (US)

(21) Appl. No.: 16/015,017

(22) Filed: Jun. 21, 2018

Related U.S. Application Data
(60) Provisional application No. 62/523,756, filed on Jun. 22, 2017.
(60) Provisional application No. 62/565,523, filed on Sep. 29, 2017.

(51) Int. Cl. G08G 1/00; G08G 1/13; H04W 4/44; H04W 4/38

(52) U.S. Cl. CPC G08G 1/205; H04W 4/38; H04W 4/44; G08G 1/13

(57) ABSTRACT

In one example embodiment, a computer-implemented method and system for providing visualization of information are disclosed. The method includes receiving current device status information for one or more IoT devices; receiving historical information for one or more IoT devices; correlating the received current device status information with the received historical information for each of the one or more IoT devices; determining overall state of each of the one or more mobile devices based on the correlation of the current device status information with historical information for each of the one or more IoT devices; and presenting the information in visual format based on the determination.

### CROSS-REFERENCE TO RELATED APPLICATIONS

Under 35 USC 119(e), this application claims priority to U.S. Provisional Application Ser. No. 62/523,756, entitled “VISUALIZATION: ICON, COLOR CODING AND HISTORICAL ROUTING INFORMATION FOR IoT DEVICES”, filed on Jun. 22, 2017 and U.S. Provisional Application Ser. No. 62/565,523, entitled “VISUALIZATION: ICON, COLOR CODING AND HISTORICAL ROUTING INFORMATION FOR IoT DEVICES”, filed on Sep. 29, 2017 and is related to U.S. application Ser. No. __/___,___, entitled “ISSUING ALERTS FOR IoT DEVICES”, filed on Jun. 21, 2018 (Attorney Docket No. 4016.915BS), all of which are herein incorporated by reference in their entirety.

### FIELD OF THE INVENTION

The embodiments described herein relate generally to network connected devices and more particularly to visualization including icon, color coding and historical routing information for IoT devices.

### BACKGROUND

In many Internet-of-Things (IoT)/Machine-to-Machine (M2M) solutions, particularly running on moving machines, for example, vehicles, it may be useful to the fleet operator to visualize a color coded representation of the state of the vehicle on a map, e.g., if the vehicle loses communication completely i.e. if it is stolen, something wrong with the vehicle.

### SUMMARY

In one example embodiment, a computer-implemented method and system for providing visualization of information are disclosed. The method includes receiving current device status information for one or more IoT devices; receiving historical information for one or more IoT devices; correlating the received current device status information with the received historical information for each of the one or more IoT devices; determining overall state of each of the one or more mobile devices based on the correlation of the current device status information with historical information for each of the one or more IoT devices; and presenting the information in visual format based on the determination.

In an embodiment, the system for visualization of information comprises at least one IoT device, a data processing system and a user interface, wherein the data processing system further comprises: a storage database, wherein the storage database receives current device status information for one or more IoT devices and historical information for one or more IoT devices; an analytics engine and a rules engine, wherein the analytics engine and the rules engine correlate the received current device status information with the received historical information for each of the one or more IoT devices and determines overall state of each of the one or more IoT devices based on the correlation of the current device status information with historical information for each of the one or more IoT devices by using rules provided by the rules engine; and a report service, wherein the report service presents the information in visual format based on the determination.

In an embodiment, a non-transitory computer-readable medium having executable instructions for providing visualization of information is disclosed. The non-transitory computer-readable medium having executable instructions stored therein that, when executed, causes one or more processors corresponding to a system having a database and a user interface to perform operations including receiving current device status information for one or more IoT devices; receiving historical information for one or more IoT devices; correlating the received current device status information with the received historical information for each of the one or more IoT devices; determining overall state of each of the one or more mobile devices based on the correlation of the current device status information with historical information for each of the one or more IoT devices; and presenting the information in visual format based on the determination.

### BRIEF DESCRIPTION OF THE DRAWINGS

FIG. 1 is an overview diagram for the method and system for visualization of information for IoT devices according to an embodiment described herein.

FIGS. 2A-D illustrate exemplary process flows for the system and method for visualization of information for IoT devices according to an embodiment described herein.

FIGS. 3A-D illustrate exemplary user interface for using the system and method for visualization of information for IoT devices according to an embodiment described herein.

FIG. 4A-F illustrate exemplary user interface for using the system and method for visualization of information for IoT devices according to an embodiment described herein.

FIG. 5 illustrates a data processing system 500 suitable for storing the computer program product and/or executing program code relating to visualization of information for IoT devices in accordance with an embodiment described herein.

### DETAILED DESCRIPTION

The embodiments described herein relate generally to communication networks, which may be cellular and/or wireless networks and more particularly to visualization including icon, color coding and historical routing information for IoT devices or mobile devices that are capable of moving, connected to a wireless communications network, such as a cellular network, and that share other characteristics, for example, vehicles belonging to a commercial fleet. The IoT devices or the mobile devices have the ability to transmit data over the internet. The transmission may also take place, for instance, through a blue-tooth connection to one's phone which uses cellular connectivity.

The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the embodiments described herein are not intended to be limited to the embodiments shown, but is to be accorded the widest scope consistent with the principles and features described herein.

In many Internet-of-Things (IoT)/Machine-to-Machine (M2M) solutions, particularly running on moving machines, for example, vehicles, it may be useful to the fleet operator to visualize a color coded representation of the state of the vehicle on a map, e.g., if the vehicle loses communication completely in events such as theft, vehicle malfunction, etc. The system and method described herein uses advanced visualization techniques to communicate key status information of one or more vehicles belonging to a fleet to system users, e.g., fleet operators. The key visualization techniques may involve representation including any one or more of: cluster, icon mapping, color-coding and historical routing representation. Alerts and visual trips are the best representations of how visualization is used to illustrate status to customers.

Generally customers or users, e.g., fleet operators, manually track the state of their assets or did not track the state at all. The method and system described herein provides the users with both, a quick holistic view and a more detail presentation of the state of their vehicles. Previously, users or fleet operators would manually maintain the status of their fleet by communicating with the drivers and vehicle operators. They would then have to manually correlate different data to determine more complex states and track the overall status of fleets on paper or in spreadsheets/documents.

In an embodiment, the system and method described herein, uses real-time or near real-time event evaluators that correlate both historical and current events to determine the overall state of individual vehicles and/or groups of vehicles. The data is stored and presented in the User Interface provided by mobile application & web application in real time or near real time. The state information is rolled up into reports and other views in the site to provide a holistic representation of the state of vehicles belonging to a particular fleet.

The system and method helps fleet managers, drivers and operators with a way to quickly determine any one or more of: which vehicles are experiencing issues, the type of issues/problems experienced by those vehicles and severity of the issues, through the unique visualization. Thus, the method and system described herein allows users to visualize the state of mobile or IoT devices, e.g., vehicles, in a unique and color-coded fashion that gives users a clear view of the state of one or more IoT devices belonging to a fleet/group of IoT devices.

In an embodiment, the system and method allows users to visualize states of one or more IoT devices e.g., vehicles, in maps.

The system and method uses color coding to represent key states of a vehicle or asset monitored by a monitoring system. For example, 1. Moving vehicles: any vehicle that is moving when the map is loaded may be shown by a green icon on the map; 2. Stopped vehicles: any vehicle that is stopped when the map is loaded may be shown by a black icon on the map; 3. Alert vehicles: any vehicle that had generated an alert may be shown by a red icon on the map, which may also be based upon the severity of the alert; 4. Offline vehicles: any vehicle that is offline (the device is disabled or for some other reason not sending the location & other data) may be shown by a grey icon on the map; 5. Cluster of vehicles: any group of vehicles that are in close proximity may be represented in a cluster-circle with the counts of vehicle. For example, a cluster may be represented by blue color, color coding may be assigned to the clusters to show the status based on the highest priority/severity status in the cluster; 6. Discovered places: added by the system and may be shown by a location icon in a green circle representing the number of visits based on the circle size. Details for discovered places may also be shown; 7. Critical: alert state of type critical may be shown in red, including icons associated with the state; 8. Warning: alert state of type critical may be shown in orange including icons associated with the state; 9. Information: alert state of type non-critical may be shown in blue including includes icons associated with the state.

The system and method described herein enables users, e.g., fleet operators, to customize their experience based on their preferences using user settings or account settings. The system and method described herein allows users to configure their icon types and website theme colors through account management settings along with other key aspects that they may be able to modify, for example, role, units (see below) and language etc.:

TABLE 1

| Field | Constraint | Description |
|---|---|---|
| User ID | Mandatory | Defines the unique email ID of the user. This |
| | | email Id is used to send the invitation link to |
| | | the user for setting up the user account. |
| Unit | Mandatory | Defines the unit of measurement to be used while |
| | | displaying values on the portal. |
| | | Metric: Displays the measurement values in |
| | | metrics, for example, Meters, liters, and |
| | | kilograms |
| | | Imperial: Displays the imperial values of the |
| | | measurements, for example, miles, feet, yards, |
| | | inches, and time zones for a particular fleet |
| | | and/or account since each account may have one |
| | | or more fleets. |
| Role | Mandatory | Defines the role to be assigned to the user. |
| Last Name | Mandatory | Defines the last name of the user. |
| Language | Mandatory | Defines the preferred language of the user to |
| | | display content on the Monitoring service/system, |
| | | e.g., AerTrak, portal in the selected language, |
| | | e.g.: |
| | | ENGLISH |
| | | BAHASA INDONESIA |
| | | JAPANESE |
| | | RUSSIAN |
| | | THINGS |
| First name | Mandatory | Defines the first name of the user. |

Icons and themes used by the system and method may be system generated or analytics driven or may be chosen and set up by the users. The system and method may allow users to define which icon represents their asset (car, truck, motorcycle, construction equipment, etc.). The users may be asked to provide an image in a scalable vector graphics (SVG) file. Additionally, or alternatively, the user may be allowed to choose the logo and colors to be used for their site. Additionally, or alternatively, the user may be allowed to choose the logo and themes to be used for their account. Additionally, or alternatively, the user may be allowed to choose map colors.

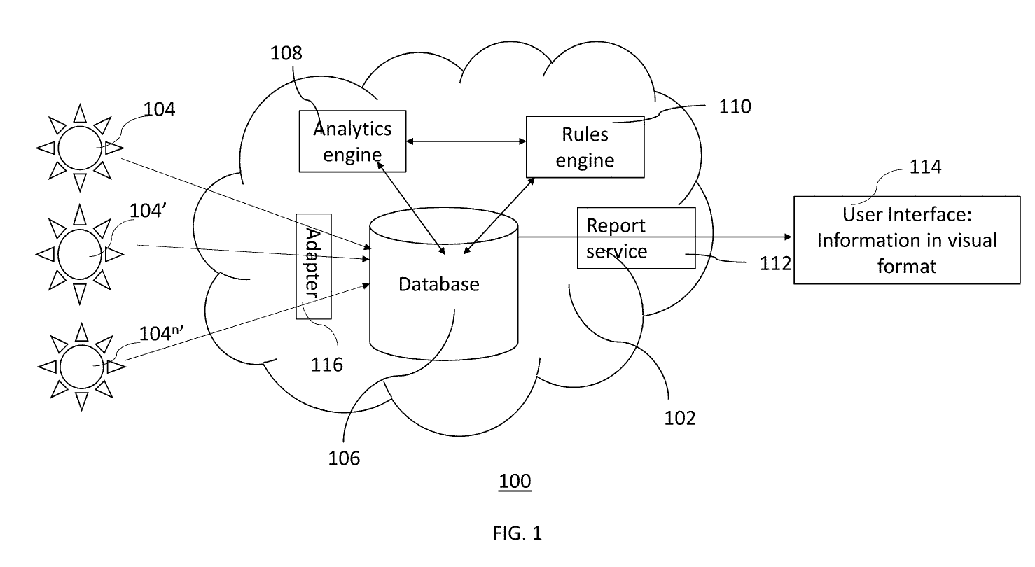

FIG. 1 is an overview diagram for the method and system for visualization of information for IoT devices according to an embodiment described herein. FIG. 1 illustrates system configuration 100 including mobile devices 104, 104′ . . . 104^{n′}, an adapter 116, a data processing system 102 including a database 106, analytics engine 108, rules engine 110, a report service 112, and a user interface 114. A system for visualization of information for IoT devices includes a storage database 106, wherein the storage database 106 receives device information for one or more mobile devices 104, including current device status information for one or more mobile devices and historical information for one or more mobile devices; an analytics engine 108, wherein the analytics engine 108 sorts and indexes the received device information using different parameters such as device identifier, time, date, location of the device etc.; a rules engine 110, wherein the rules engine 110 provides rules to the data processing system 102 or the analytics engine 108 to correlate the received current device status information with the received historical information for each of the one or more mobile devices to determine the overall state of each device, which is stored in the storage database 106 and the report service 112 retrieves the data from the storage database 106 and presents the information in visual format based on the determination of the overall state.

The mobile devices 104, 104′, . . . 104^{n′} may include IoT devices capable of communication, for example, vehicles connected to the cellular network or cellular-enabled devices via SIMs that are installed in the mobile or IoT devices as either integrated in the vehicle itself or removably installed in the vehicle on each of the fleet vehicle. These communication devices could be devices using a radio module and Wifi, or any other wireless communication technology that are capable of transmitting relevant vehicle data to database 106 and/or the data processing system 102 of the monitoring system.

In an embodiment, the devices, e.g., vehicles, may have monitoring devices installed in them, that are also capable of communication via SIMs that are installed in them. These monitoring devices may also be devices using a radio module and Wifi, or any other wireless communication technology that are capable of transmitting relevant vehicle/monitoring data to database 106 and/or the data processing system 102 of the monitoring system.

Moving devices either directly or via monitoring devices installed in them, send various data to a database as they perform their jobs. This data may be processed further by extracting information for relevant fields using application programming interface (API) keys to read data contained in specific data fields.

In an embodiment, the data may be containerized and stored based on a subscription identifier. The data is accessed through APIs using API keys and user authentication to securely transmit the data. Management of data received from these devices and access to application specific data to be used by specific applications is described in a related U.S. patent application Ser. No. 14/207,378, entitled, “MANAGEMENT OF DATA FEEDS FROM DEVICES AND PUBLISHING AND CONSUMPTION OF DATA” filed Mar. 12, 2014 and is herein incorporated by reference in its entirety.

In another embodiment, device data sent directly from the devices to the storage database may also be used, where the data may be accessed through APIs using API keys and user authentication to securely transmit the data.

In yet another embodiment, the device data is sent to a data processor, e.g., adapter 116, where it is processed and then sent to the storage database 106 to be used by the analytics engine.

Various data are collected from the moving devices either directly or via monitoring devices installed in them, as they perform their jobs. The gathered data may include route information along with the device records, for example, device identifier, start location of the route, destination location for the route, location of the device at time t=0 . . . n, time of the day for the travel, day of the week for the travel, time taken for or duration of the travel, distance covered during the travel, etc. The system may further involve usage of a computer to determine proximity to a location of interest, e.g., starting location, ending location, locations on route etc., among a vast number of such locations on a map using radius of proximity. The gathered data may further include fuel level, coolant temperature/level, speed, location, radius for geofence, accidents, odometer readings, time of the day, duration of travel, voltage level of monitoring device, ignition status of the IoT device, power level/battery status, monitoring device status, e.g., plugged/unplugged, vehicle deceleration etc. The devices may also report On-Board Diagnostics version 2 Diagnostic Trouble Code (OBDII DTC), J1939 (which is a standard for communication among vehicle components by Society of Automotive Engineers (SAE)), fault, battery voltage and faults regarding other components such as lamps. Backend systems may receive device status as ignition on and off or changes in ignition status, idle time, e.g., when ignition is on but no movement is recorded in terms of location with respect to time, e.g., GPS movement.

This gathered data is analyzed by the processing component of the system such as an analytics engine, by comparing the parameters of the gathered data with the threshold conditions provided to the system. If any of the parameters of the gathered data exceed the pre-determined or pre-defined threshold parameters, an alert may be issued by the monitoring system. The method and system for issuing alerts is described in U.S. application Ser. No. __/___,___, entitled “ISSUING ALERTS FOR IoT DEVICES”, filed on Jun. 21, 2018 (Attorney Docket No. 4016.915BS) and is herein incorporated by reference in its entirety.

For example, an alert may be issued for an IoT or mobile device as it goes around performing a job assigned to it, regarding geofencing, device behavior and/or driver behavior for devices. The issued alert is stored in the storage database, along with other information including any one or more of: location of the device when the alert was issued, time of the day, day of the week and/or date when the alert was issued, device identifier, operator of the device, etc. The severity of the issued alert is also stored in the one or more storage databases. This alert as well as severity of the generated alert information along with routing information for that device provides historical information for that device. The historical information for a device may further include any one or more of: the device's\vehicle's location (latitude/longitude, address etc.), routing information for the device, device status, e.g., moving/idle/stopped, state of vehicle over the course of time, sensor readings, etc. which helps identify patterns for that device. The historical information of the device may also help identify an event that may generate an alert, e.g., if a device is going over a pre-defined or pre-determined threshold speed limit for x # times in a row would indicate an event of speeding, or if a devices location has changed multiple times over a pre-defined or pre-determined period of time e.g., one minute, 2 minutes etc., then that device is considered as moving. Thus, historical information of a device may include any one or more of: issued alert, location of the device when the alert was issued, time of the day, day of the week, date when the alert was issued, severity of the issued alert, location of the device, routing information for the device, status of the device, state of device over the course of time, sensor reading for the device, duration of time spent by the device at a specific location, speed of the device, acceleration/deceleration of the device, ignition status of the device, fuel level of the device, battery level of the device, plugged/unplugged status of the device, duration of time for which no device information is received, device identifier and operator of the device.

The device information received by the one or more storage databases may thus include any one or more of: current status of the device, historical information for the device, location information of the device indexed by time and other device information including a device identifier, operator of the device, location of the device, duration of time spent by the device at a specific location, speed of the device, acceleration/deceleration of the device, ignition status of the device, fuel level of the device, battery level of the device, plugged/unplugged status of the device and duration of time for which no device information is received, etc. The current status of the device may include any one or more of: a device identifier, operator of the device, current location of the device, current state of the device (moving/idle/stopped), current sensor data, current speed of the device, acceleration/deceleration of the device, current ignition status of the device, current fuel level of the device, current battery level of the device, current plugged/unplugged status of the device and duration of time for which no device information is received, etc.

The analytics engine 108 correlates historical data for a device with the current status data for that device to determine the overall state of the device. For example, a device is considered speeding when x consecutive readings of speed are over a pre-defined or pre-determined threshold speed limit. Another example is if the device has not moved for x-amount of time, it is considered as idling. In most cases this historical data used for evaluating state of the device is stored in cache (along with the data store) for immediate retrieval. The correlation of historical data for a device with the current status data for that device includes compiling device status information for one or more mobile devices based on any one or more of: device identifier, device operator, trip identifier, location coordinates and alert information. This data is stored in a storage database and presented in the User Interface provided by the mobile application and/or web application in real time or near real time. This stored state information may be used to generate reports and other views in the mobile or web user interface by a report service 112, which generates reports by compiling the relevant information retrieved from the one or more databases, to provide a holistic representation of the state of the one or more vehicles belonging to a particular fleet.

The main logic for retrieving data is handled on the client which may be a mobile application or a web application. The logic is as follows: Current location and/or other data described above for desired vehicles, which may be specific vehicles or all vehicles belonging to a particular fleet, is retrieved from the data store. This may be done by retrieving data from the server or a data storage, which may be a physical data storage or may be cloud based data storage, by using representational state transfer (REST) webservices that will in turn obtain data from microservice via message queues. The microservices are responsible for retrieving data from a data store. For example, a client may request data from server through the client facing REST services using message: GET ASSET Location (api/fleet/assets), and the server may provide data using the response including AssetID, Latitude and longitude. This is passed back as a JSON OBJECT, as shown below using location data example.

{

“sequenceNumber”: 29065,
“updateTime”: 1529433160,
“timeOfFix”: 1529433160,
“latitude”: 11.746055,
“longitude”: 11.9934163,
“altitude”: 39553,
“speed”: 0,
“heading”: 8,
“satellites”: 12,
“carrier”: 20,
“rssi”: −87,
“hdop”: 0.8,
“inputs”: 3,
“fixStatus”: 2,
“eventType”: 10,
“devicePowerVoltage”: 13,
“assetState”: on

},
{

“sequenceNumber”: 29064,
“updateTime”: 1529433100,
“timeOfFix”: 1529433100,
“latitude”: 11.74604559999999,
“longitude”: 11.9934183,
“altitude”: 39606,
“speed”: 0,

....

New data may be posted or existing data may be updated into the data storage 106 directly or via adapter 116 as described above. Since the use of REST webservices is based on API, no user interface and/or human interaction may be involved in retrieving data from the server. The REST API services retrieve data through microservices. Microservices may help retrieve different information via smaller queries, generally performing a single function, from NO-SQL data structures or distributed databases, e.g., Cassandra, MongoDB etc. This retrieved information may then be compiled in a report format, based on user requests.

To present color coded data, a configuration file containing color code mapping to states, which may also be stored in the database 106, is used by the reporting service 112, which retrieves the state information from the database 106 and assigns color codes based on the mapping stored in configuration file.

To present data in a map, the report service 112 retrieves data via APIs as described above and then renders it on a map, which may be provided by a commercial mapping product. All states for the devices of interest are determined via the real-time event processing by the analytics engine 108 and rules engine 110, and then stored in the database 106. Additionally, the system may present color coded data in a map using the processes described above.

All data, including geofence, for places associated with the fleet are retrieved from the data store using REST web services via microservices as described above. The received device data e.g., vehicle locations are compared to the geofence data to determine the following: (a) Count of vehicles associated with a given place; (b) Counts of vehicles with no last known location; (c) Counts of vehicles not in a specific location (in transit); (d) When the vehicles count doesn't match with the number of vehicles in the fleet, there will be “**” next to the total count of vehicles on both top and bottom of the status summary. Once the results are obtained, they may be compiled in a desired format and rendered to the mobile and/or web interface as desired by the user.

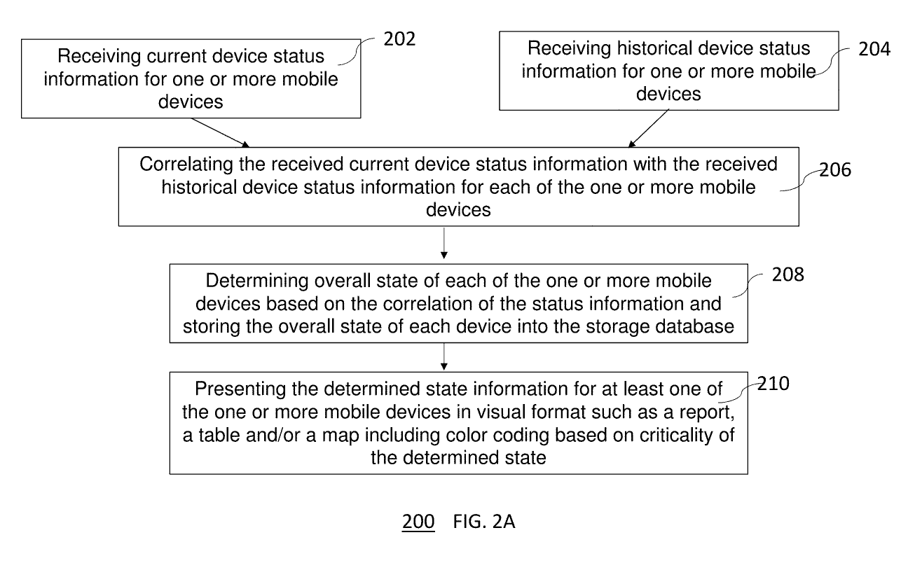

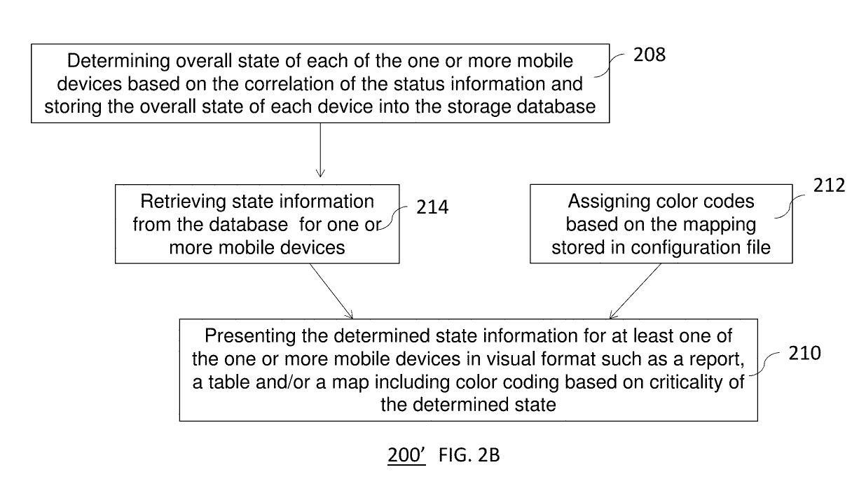

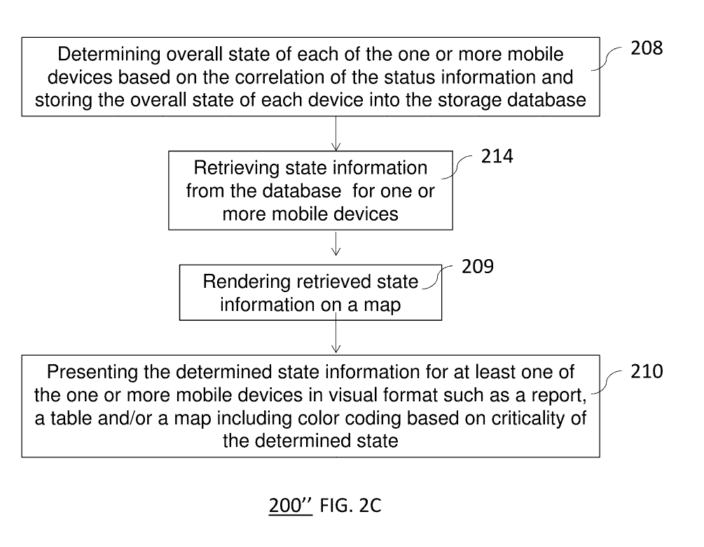

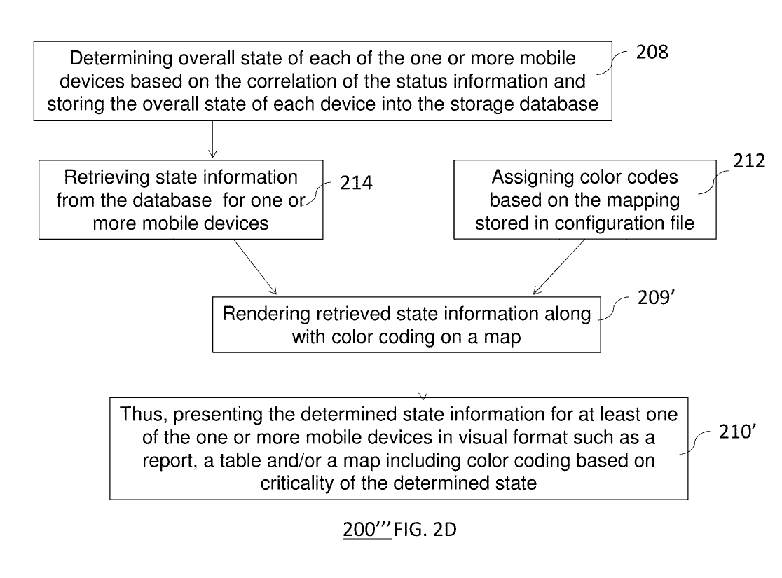

FIG. 2A-D illustrate an exemplary process flows for the system and method for visualization of information for IoT devices according to an embodiment described herein. As illustrated in FIG. 2A, the method includes receiving current device status information for one or more mobile devices via step 202 and receiving historical information for one or more mobile devices via step 204; correlating the received current device status information with the received historical information for each of the one or more mobile devices via step 206; evaluating the correlated device information to determine overall state of each of the one or more mobile devices based on the correlation of the status information and storing it in a storage database via step 208; and presenting the determined state information for at least one of the one or more mobile devices in visual format such as a report, a table and/or a map including color coding based on criticality of the determined state via step 210.

Moving devices either directly or via monitoring devices installed in them, send various data to a database as they perform their jobs. This data may be processed further by extracting information for relevant fields using application programming interface (API) keys to read data contained in specific data fields.

In an embodiment, the data may be containerized and stored based on a subscription identifier. The data may be accessed through APIs using API keys and user authentication to securely transmit the data. Management of data received from these devices and access to application specific data to be used by specific applications is described in a related U.S. patent application Ser. No. 14/207,378, entitled, “MANAGEMENT OF DATA FEEDS FROM DEVICES AND PUBLISHING AND CONSUMPTION OF DATA” filed Mar. 12, 2014 and is herein incorporated by reference in its entirety.

In another embodiment, device data sent directly from the devices to the storage database may also be used, where the data may be accessed through APIs using API keys and user authentication to securely transmit the data.

In yet another embodiment, the device data is sent to a data processor, e.g., an adapter 116, where it is processed and then sent to the storage database 106 to be used by the analytics engine.

Various data are collected from the moving devices either directly or via monitoring devices installed in them, as they perform their jobs. The gathered data may include route information along with the device records, for example, device identifier, start location of the route, destination location for the route, location of the device at time t=0 . . . n, time of the day for the travel, day of the week for the travel, time taken for or duration of the travel, distance covered during the travel, etc. The system may further involve usage of a computer to determine proximity to a location of interest, e.g., starting location, ending location, locations on route etc., among a vast number of such locations on a map using radius of proximity. The gathered data may further include fuel level, coolant temperature/level, speed, location, radius for geofence, accidents, odometer readings, time of the day, duration of travel, voltage level of monitoring device, ignition status of the IoT device, power level/battery status, monitoring device status, e.g., plugged/unplugged, vehicle deceleration etc. The devices may also report On-Board Diagnostics version 2 Diagnostic Trouble Code (OBDII DTC), J1939 (which is a standard for communication among vehicle components by Society of Automotive Engineers (SAE)), fault, battery voltage and faults regarding other components such as lamps. Backend systems may receive device status as ignition on and off or changes in ignition status, idle time, e.g., when ignition is on but no movement is recorded in terms of location with respect to time, e.g., GPS movement.

This gathered data is analyzed by the processing component of the system such as an analytics engine, by comparing the parameters of the gathered data with the threshold conditions provided to the system. If any of the parameters of the gathered data exceed the pre-determined or pre-defined threshold parameters, an alert may be issued by the monitoring system. The method and system for issuing alerts is described in U.S. application Ser. No. __/___,___, entitled “ISSUING ALERTS FOR IoT DEVICES”, filed on Jun. 21, 2018 (Attorney Docket No. 4016.915BS) and is herein incorporated by reference in its entirety.

For example, an alert may be issued for an IoT or mobile device as it goes around performing a job assigned to it, regarding geofencing, device behavior and/or driver behavior for devices. The issued alert is stored in the storage database, along with other information including any one or more of: location of the device when the alert was issued, time of the day, day of the week and/or date when the alert was issued, device identifier, operator of the device, etc. The severity of the issued alert is also stored in the one or more storage databases. This alert as well as severity of the generated alert information along with routing information for that device provides historical information for that device. The historical information for a device may further include any one or more of: the device's\vehicle's location (latitude/longitude), routing information for the device, status, e.g., moving/idle/stopped, state of vehicle over the course of time, sensor readings, etc. which helps identify patterns for that device. The historical information of the device may also help identify an event that may generate an alert, e.g., if a device is going over a pre-defined or pre-determined threshold speed limit for x # times in a row would indicate an event of speeding, or if a devices location has changed multiple times over a pre-defined or pre-determined period of time e.g., one minute, then that device is considered as moving. Thus, the historical information of a device may include any one or more of: issued alert, location of the device when the alert was issued, time of the day, day of the week, date when the alert was issued, severity of the issued alert, location of the device, routing information for the device, status of the device, state of device over the course of time, sensor reading for the device, duration of time spent by the device at a specific location, speed of the device, acceleration/deceleration of the device, ignition status of the device, fuel level of the device, battery level of the device, plugged/unplugged status of the device, duration of time for which no device information is received, device identifier and operator of the device.

The device information received by the one or more storage databases may thus include any one or more of: current status of the device, historical information for the device, location information of the device indexed by time and other device information including a device identifier, operator of the device, location of the device, duration of time spent by the device at a specific location, speed of the device, acceleration/deceleration of the device, ignition status of the device, fuel level of the device, battery level of the device, plugged/unplugged status of the device and duration of time for which no device information is received, etc. The current status of the device may include any one or more of: a device identifier, operator of the device, current location of the device, current state of the device (moving/idle/stopped), current sensor data, current speed of the device, acceleration/deceleration of the device, current ignition status of the device, current fuel level of the device, current battery level of the device, current plugged/unplugged status of the device and duration of time for which no device information is received.

The historical data for a device with the current status data for that device is correlated to determine the overall state of the device via steps 206 and 208 as described above. For example, a device is considered speeding when x consecutive readings of speed are over a pre-defined or pre-determined threshold speed limit. Another example is if the device has not moved for x-amount of time, it is considered as idling. In most cases this historical data used for evaluating state of the device is stored in cache (along with the data store) for immediate retrieval. The correlation of historical data for a device with the current status data for that device includes compiling device status information for one or more mobile or IoT devices or for a particular mobile or IoT device may be based on any one or more of: device identifier, device operator, trip identifier, location coordinates and alert information. This data is stored in a storage database via step 208 and presented in the User Interface provided by the mobile application and/or web application in real time or near real time. This stored state information may be used to generate reports and other views in the mobile or web user interface by a report service, which generates reports by compiling the relevant information retrieved from the one or more databases, to provide a holistic representation of the state of the one or more vehicles belonging to a particular fleet in visual format, for example, a report; a table; a map; color coded graphs, icons etc. based on criticality of the determined state via step 210.

The main logic for retrieving data is handled on the client which may be a mobile application or a web application. The logic is as follows: Current location and/or other data described above for desired vehicles, which may be specific vehicles or all vehicles belonging to a particular fleet, is retrieved from the data store. This may be done by retrieving data from the server or a data storage, which may be a physical data storage or may be cloud based data storage. The process for retrieving the data by the reporting service using representational state transfer (REST) webservices that will in turn obtain data from microservice via message queues is described in detail above in the description accompanying FIG. 1.

FIG. 2B illustrates an exemplary process flows for the system and method for visualization of information for IoT devices according to an embodiment described herein. As illustrated in FIG. 2B, the process to present color coded data, uses a configuration file containing color code mapping to states, which may also be stored in the database. The process includes retrieving the state information from the database via step 214, which is determined and stored in the database via steps 202-208 as shown in FIG. 2A and described in detail above in the description accompanying FIG. 2A; assigning color codes based on the mapping stored in configuration file via step 212; and presenting the determined state information for at least one of the one or more mobile devices in visual format such as a report, a table and/or a map including color coding based on criticality of the determined state via step 210.

FIG. 2C illustrates an exemplary process flows for the system and method for visualization of information for IoT devices according to an embodiment described herein. As illustrated in FIG. 2C, the process to present data in a map, includes retrieving the state information data via APIs as described above, via step 214, which is determined and stored in the database via steps 202-208 as shown in FIG. 2A and described in detail above in the description accompanying FIG. 2A; and rendering it on a map 209, which may be provided by a commercial mapping product. The process thus includes presenting the determined state information for at least one of the one or more mobile devices in visual format such as a report, a table and/or a map including color coding based on criticality of the determined state as illustrated by step 210. All states for the devices of interest are determined via the real-time event processing by the analytics engine and rules engine, and then stored in the database.

FIG. 2D illustrates an exemplary process flows for the system and method for visualization of information for IoT devices according to an embodiment described herein. As illustrated in FIG. 2D, the process to present color coded data in a map includes retrieving the state information from the database via step 214, which is determined and stored in the database via steps 202-208 as shown in FIG. 2A, and described in detail above in the description accompanying FIG. 2A; assigning color codes based on the mapping stored in configuration file via step 212; and rendering it on a map via step 209′, thereby presenting the determined state information for at least one of the one or more mobile devices in visual format such as a report, a table and/or a map including color coding based on criticality of the determined state as illustrated by step 210′. This process may also be performed in a different sequence, e.g., the state may be first rendered on the map and then color coded. A configuration file containing color code mapping to states may be stored in the database. The map may be provided by a commercial mapping product. All states for the devices of interest are determined via the real-time event processing by the analytics engine and rules engine, and then stored in the database.

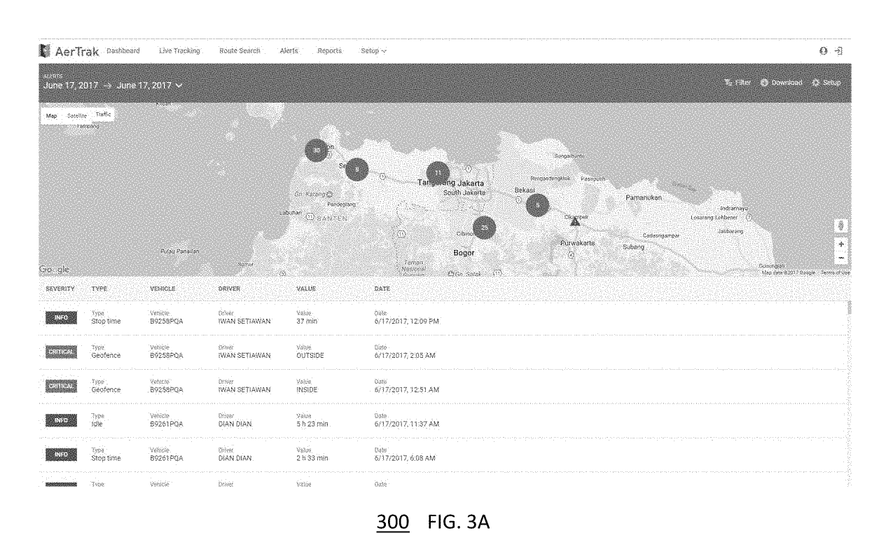

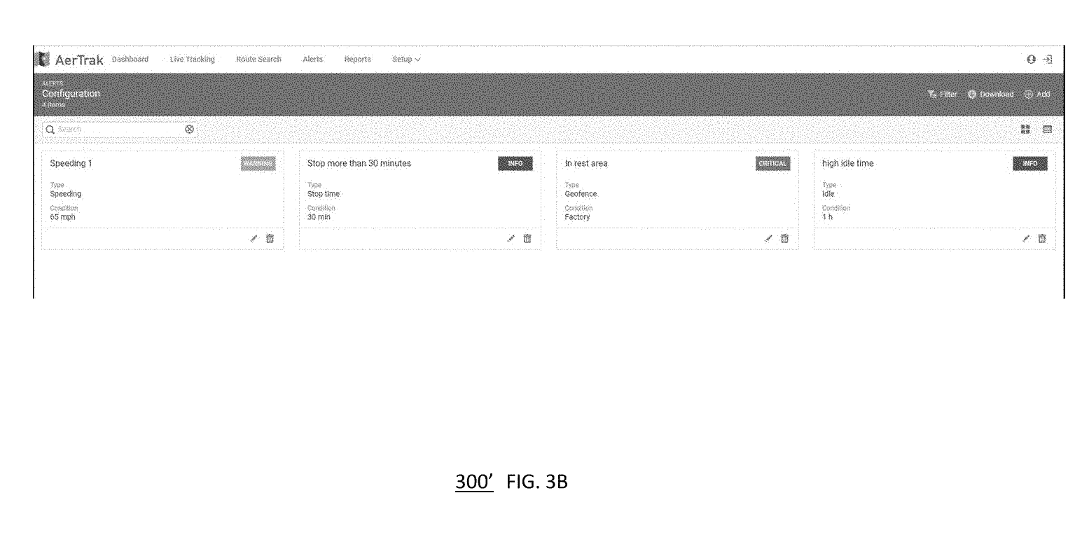

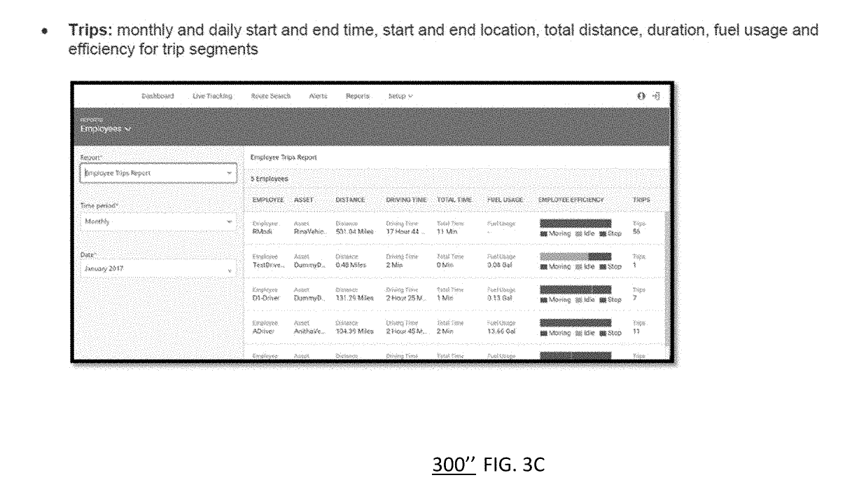

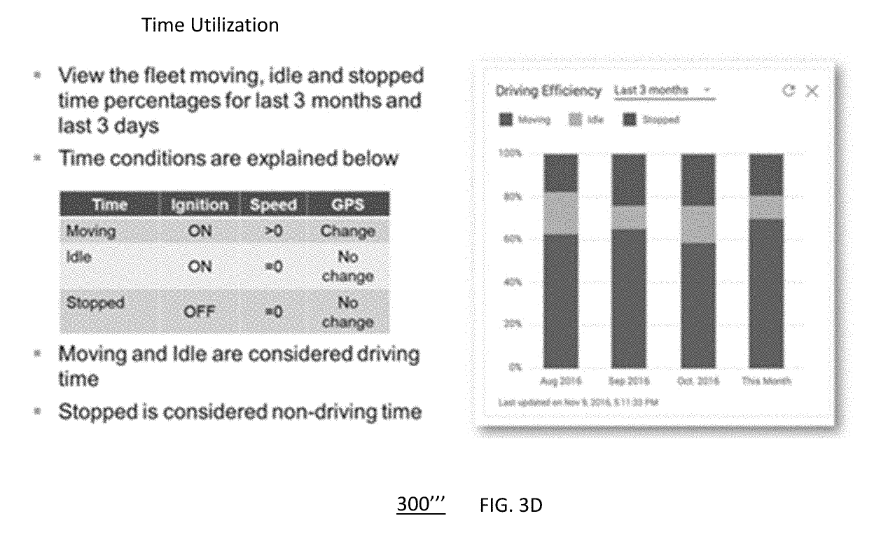

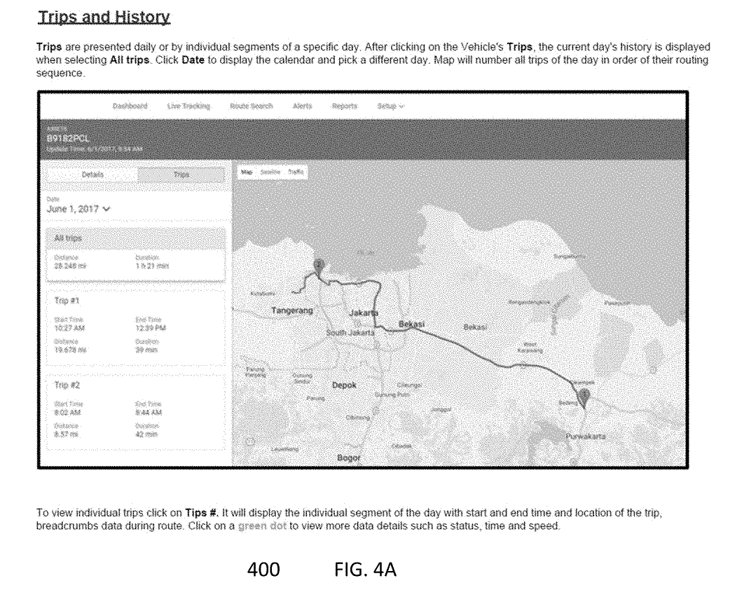

FIGS. 3A-D illustrate exemplary user interface for using the system and method for visualization of information for IoT devices according to an embodiment described herein. For example, FIGS. 3A-C illustrate alerts screen presenting visualization of alerts.

FIG. 3A illustrates an exemplary user interface showing a cluster of alerts on alert screen, where numbers in the circle represent number of alerts. When the user clicks on a circle, he is able to see different alerts included in that cluster of alerts. Additionally, the circle may be color coded red if there is any critical alert in the list represented by that cluster.

As illustrated, this page displays alerts triggered by devices or drivers. There are optional filters on a left side panel to select the view of alerts on list form and on the map. Some guideline for key information in the alert page may include 1. Timestamp—Indicates the local time the alert was triggered; 2. Alert Type—Indicates the name of the triggered alert, which typically describes the vehicle behavior associated with the alert; 3. Severity—indicates how severe is the alerts as set by the user. Red indicates critical, Orange indicates warning, Blue indicates information; 3. Vehicle—Name of the vehicle that triggered the alert; 4. Driver—Name of vehicle driver when the alert was triggered; 5. Value—Field value that caused the alert to trigger; 6. Location—Displays the location on the map where the alert event occurred; 7. Calendar Range: select the time range to filter for specific alerts on specific dates; 8. Filter by Severity: select the alert type severity critical, warning or information to list only those specific alerts land view on the map; 9. Filter by Alert Type: select the type of alert to list only those specific alerts land view on the map; 10. Filter by Vehicle: enter a vehicle ID to search for specific alerts for that one vehicle; 11. Alert Counts: View the total number of alerts by severity and type, and updated counts when filter by any of the options.

FIG. 3B illustrates an exemplary user interface for allowing a user to configure the alerts. As illustrated in FIG. 3B, the user may configure different alerts by entering respective threshold conditions and assigning a level of severity to that alert at that threshold conditions. For example, a user may set a speeding alert when the vehicle exceed threshold condition of 65 mph and the alert may be issued as a warning. Different levels of severity may be assigned for different threshold conditions, e.g., the severity of speeding alert may be assigned as critical when the speed of the vehicle exceeds threshold speed limit of 85 mph.

FIG. 3C illustrates an exemplary user interface for displaying employee trip report, where employee efficiency is represented as moving, idle and stop time for each employee and color coding each.

FIG. 3D illustrates time utilization of devices for a particular duration, for example, 1 month, 3 months etc. and may be color coded as described above and illustrated in FIG. 3D, for example, moving time (BLUE), idle time (ORANGE) , Stopped time (RED) which may be shown in the time utilization chart.

In an embodiment, the users may be allowed to modify the colors associated with states of the IoT devices. The users may also be allowed to assign a severity level to a particular alert state, e.g., critical, warning, etc., which in turn may have a color associated with it. The states of the device may be determined based on device data analytics using historical data for a device and correlating it with the current data received from that device. The correlation of historical data for a device with the current status data for that device includes compiling device status information for one or more mobile or IoT devices based on any one or more of: device identifier, device operator, trip identifier, location coordinates and alert information. This is achieved by using data analytics and machine learning to identify an anomalous state and by allowing the user to define the new state and associate the assigned state with a color code, which may also be chosen by the user. For example, if a vehicle typically visits a certain location on a certain day of the week, or at a certain time of the day, and then deviates from that pattern, such deviation from the pattern observed using historical information may be classified as an anomalous state, or if a sensor typically has a standard value and if a sensor reading deviates from that value, it would be classified as an anomalous state for that device.

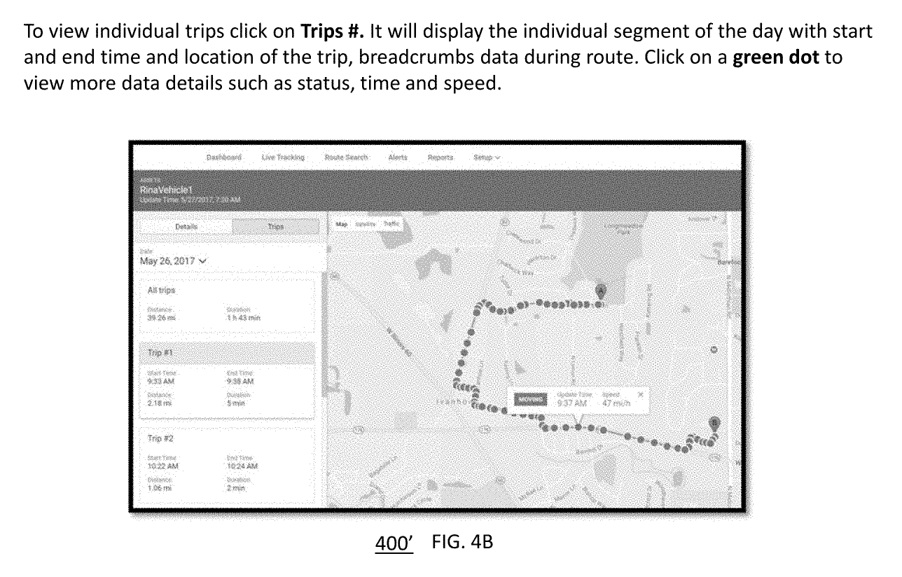

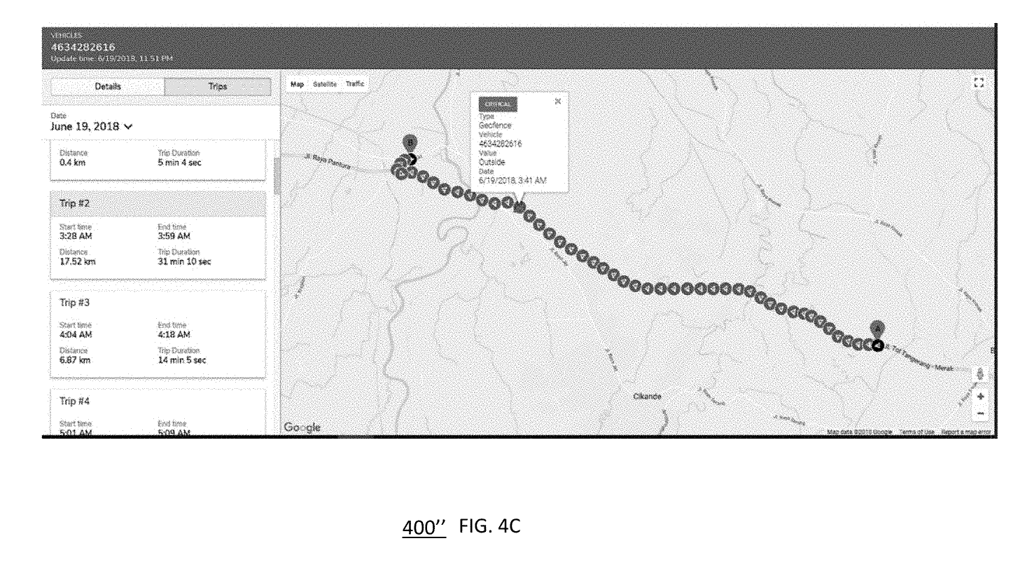

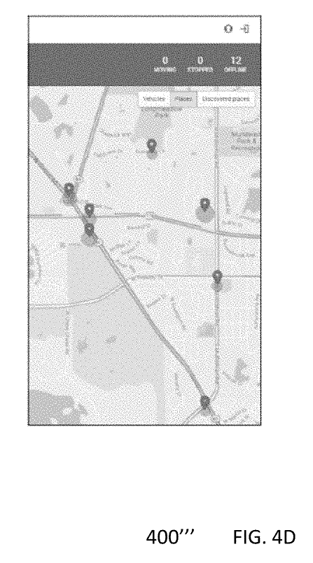

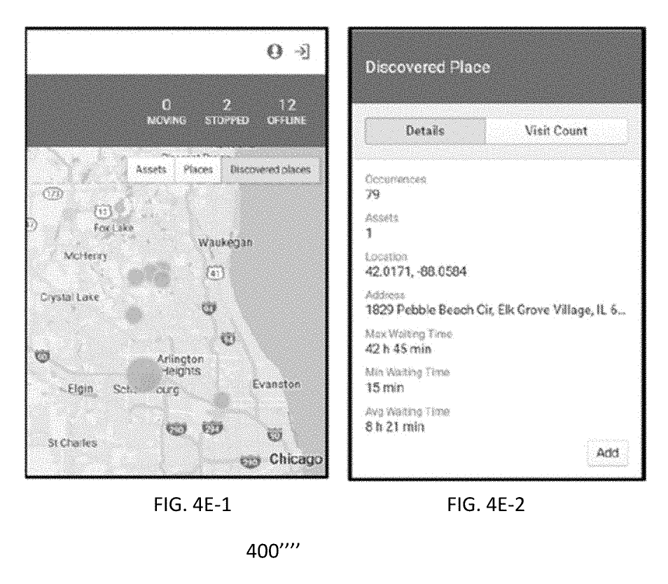

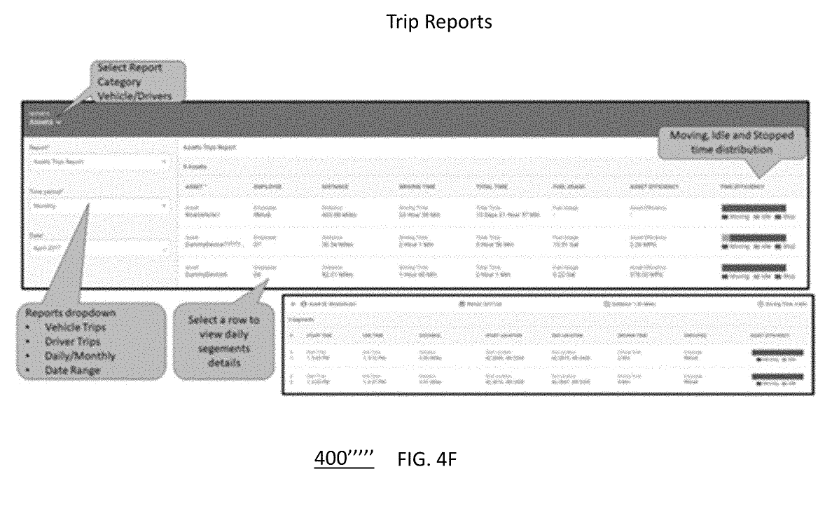

FIG. 4A-E illustrate exemplary user interface for using the system and method for visualization of information for IoT devices according to an embodiment described herein. For example, FIG. 4A illustrates an exemplary user interface depicting Visual Trips. As illustrated by FIG. 4A, trips may be presented daily or by individual segments of a specific day. The user can click on trip number to display individual segment of the day with start and end time and location of the trip. Clicking on a trip display map shown in FIG. 4A will provide a visual representation of breadcrumbs data during the route as depicted by FIG. 4B. The user can view more data details such as status, time and speed by clicking on a green dot as shown in FIG. 4B.

FIG. 4C illustrates an exemplary user interface providing a visual representation of breadcrumbs data during the route. The system and method may color code a breadcrumb dot to be a red dot/triangle if there is an alert as shown in FIG. 4C. The user can observe additional details of the alert when hovered over the red dot/triangle, e.g., a critical alert issued for geofence violation by vehicle ID, type of violation, date and time of violation.

FIG. 4D illustrates an exemplary user interface depicting geofences around a location point depicted by a light red circle surrounding a bright red location point.

FIGS. 4E1 and 4E2 illustrate an exemplary user interface depicting discovered places or locations of interest. As shown in FIG. 4E-1, any new discovered places added by the system is shown by a location icon in a green circle, where the circle sixe is based upon the number of visits to that location. As shown in FIG. 4E-2, discovered places details such as location coordinates, street address, number of visits, number of devices visiting that location, min waiting time as well as average waiting time are displayed.

FIG. 4F illustrates trip reports for a specified duration, for example, daily, weekly or monthly segment reports etc. and may be color coded as described above and illustrated in FIG. 4F, for example, moving time (BLUE), idle time (ORANGE) Stopped time (RED) which may be shown in the trip reports chart.

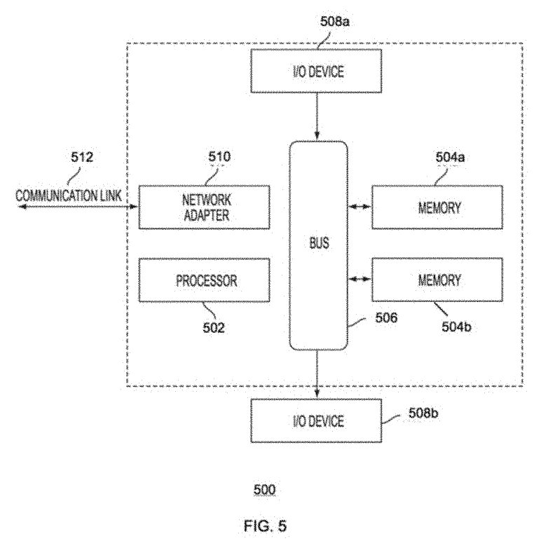

FIG. 5 illustrates a data processing system 500 suitable for storing the computer program product and/or executing program code in accordance with an embodiment of the present invention. The data processing system 500 includes a processor 502 coupled to memory elements 504a-b through a system bus 506. In other embodiments, the data processing system 500 may include more than one processor and each processor may be coupled directly or indirectly to one or more memory elements through a system bus.

Memory elements 504a-b can include local memory employed during actual execution of the program code, bulk storage, and cache memories that provide temporary storage of at least some program code in order to reduce the number of times the code must be retrieved from bulk storage during execution. As shown, input/output or I/O devices 508a-b (including, but not limited to, keyboards, displays, pointing devices, etc.) are coupled to the data processing system 500. I/O devices 508a-b may be coupled to the data processing system 500 directly or indirectly through intervening I/O controllers (not shown).

In FIG. 5, a network adapter 510 is coupled to the data processing system 502 to enable data processing system 502 to become coupled to other data processing systems or remote printers or storage devices through communication link 512. Communication link 512 can be a private or public network. Modems, cable modems, and Ethernet cards are just a few of the currently available types of network adapters.

Embodiments of the process described herein can take the form of an entirely software implementation, or an implementation containing both hardware and software elements. Embodiments may be implemented in software, which includes, but is not limited to, application software, firmware, resident software, microcode, etc.

The steps described herein may be implemented using any suitable controller or processor, and software application, which may be stored on any suitable storage location or computer-readable medium. The software application provides instructions that enable the processor to cause the receiver to perform the functions described herein.

Furthermore, embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-R/W).

Any theory, mechanism of operation, proof, or finding stated herein is meant to further enhance understanding of the present invention and is not intended to make the present invention in any way dependent upon such theory, mechanism of operation, proof, or finding. It should be understood that while the use of the words “preferable”, “preferably” or “preferred” in the description above indicates that the feature so described may be more desirable, it nonetheless may not be necessary and embodiments lacking the same may be contemplated as within the scope of the invention, that scope being defined by the claims that follow. In addition, it should be understood that while the use of words indicating a sequence of events such as “first” and “then” shows that some actions may happen before or after other actions, embodiments that perform actions in a different or additional sequence should be contemplated as within the scope of the invention as defined by the claims that follow.

As used herein, the term “communication” is understood to include various methods of connecting any type of computing or communications devices, servers, clusters of servers, using wired and/or wireless or cellular communications networks to enable processing and storage of signals and information, and where these services may be accessed by applications available through a number of different hardware and software systems, such as but not limited to a web browser terminal, mobile application (i.e., app) or similar, and regardless of whether the primary software and data is located on the communicating device or are stored on servers or locations apart from the devices.

As used herein the terms “device”, “appliance”, “terminal”, “remote device”, “wireless asset”, etc. are intended to be inclusive, interchangeable, and/or synonymous with one another and other similar communication-based equipment for purposes of the present invention, even though one will recognize that functionally each may have unique characteristics, functions and/or operations which may be specific to its individual capabilities and/or deployment.

Similarly, it is envisioned by the present invention that the term “wireless network” includes networks using one or more communication architectures or methods, including but not limited to: Code division multiple access (CDMA), Global System for Mobile Communications (GSM) (“GSM” is a trademark of the GSM Association), Universal Mobile Telecommunications System (UMTS), Long Term Evolution (LTE), 4G LTE, 5G, wireless local area network (WIFI) and Ethernet.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

What is claimed is:

1. A computer-implemented method for providing visualization of information comprising:
receiving current device status information for one or more IoT devices;
receiving historical information for one or more IoT devices;
correlating the received current device status information with the received historical information for each of the one or more IoT devices;
determining overall state of each of the one or more mobile devices based on the correlation of the current device status information with historical information for each of the one or more IoT devices; and
presenting the information in visual format based on the determination.

2. The computer-implemented method of claim 1, wherein the current device status information for one or more IoT devices includes any one or more of: a device identifier, operator of the device, current location of the device, current state of the device, current sensor data, current speed of the device, acceleration/deceleration of the device, current ignition status of the device, current fuel level of the device, current battery level of the device, current plugged/unplugged status of the device and duration of time for which no device information is received.

3. The computer-implemented method of claim 1, wherein the historical information for one or more IoT devices includes any one or more of: issued alert, location of the device when the alert was issued, time of the day, day of the week, date when the alert was issued, severity of the issued alert, location of the device, routing information for the device, status of the device, state of device over the course of time, sensor reading for the device, duration of time spent by the device at a specific location, speed of the device, acceleration/deceleration of the device, ignition status of the device, fuel level of the device, battery level of the device, plugged/unplugged status of the device, duration of time for which no device information is received, device identifier and operator of the device.

4. The computer-implemented method of claim 1, wherein correlating the received current device status information with the received historical information for each of the one or more IoT devices comprises compiling device status information for one or more mobile devices based on any one or more of: device identifier, device operator, trip identifier, location coordinates and alert information.

5. The computer-implemented method of claim 1, wherein presenting the information in visual format comprises any one or more of a report, a table, a map and color coding the visual representation.

6. The computer-implemented method of claim 5, wherein color coding the visual representation is based on criticality of the determined state.

7. A system for providing visualization of information, the system comprising at least one IoT device, a data processing system and a user interface, wherein the data processing system further comprises:
a storage database, wherein the storage database receives current device status information for one or more IoT devices and historical information for one or more IoT devices;
an analytics engine and a rules engine, wherein the analytics engine and the rules engine correlate the received current device status information with the received historical information for each of the one or more IoT devices and determines overall state of each of the one or more IoT devices based on the correlation of the current device status information with historical information for each of the one or more IoT devices by using rules provided by the rules engine; and
a report service, wherein the report service presents the information in visual format based on the determination.

8. The system of claim 7, wherein the current device status information for one or more IoT devices includes any one or more of: a device identifier, operator of the device, current location of the device, current state of the device, current sensor data, current speed of the device, acceleration/deceleration of the device, current ignition status of the device, current fuel level of the device, current battery level of the device, current plugged/unplugged status of the device and duration of time for which no device information is received.

9. The system of claim 7, wherein the historical information for one or more IoT devices includes any one or more of: issued alert, location of the device when the alert was issued, time of the day, day of the week, date when the alert was issued, severity of the issued alert, location of the device, routing information for the device, status of the device, state of device over the course of time, sensor reading for the device, duration of time spent by the device at a specific location, speed of the device, acceleration/deceleration of the device, ignition status of the device, fuel level of the device, battery level of the device, plugged/unplugged status of the device, duration of time for which no device information is received, device identifier and operator of the device.

10. The system of claim 7, wherein the received current device status information with the received historical information for each of the one or more IoT devices is correlated by compiling device status information for one or more mobile devices based on any one or more of: device identifier, device operator, trip identifier, location coordinates and alert information.

11. The system of claim 7, wherein the information in visual format is presented as any one or more of a report, a table, a map and color coding the visual representation.

12. The system of claim 11, wherein color coding the visual representation is based on criticality of the determined state.

13. A non-transitory computer-readable medium having executable instructions stored therein that, when executed, cause one or more processors corresponding to a system for providing visualization of information having a database and a user interface to perform operations comprising:
receiving current device status information for one or more IoT devices;
receiving historical information for one or more IoT devices;
correlating the received current device status information with the received historical information for each of the one or more IoT devices;
determining overall state of each of the one or more mobile devices based on the correlation of the current device status information with historical information for each of the one or more IoT devices; and
presenting the information in visual format based on the determination.

14. The non-transitory computer-readable medium of claim 13, wherein the current device status information for one or more IoT devices includes any one or more of: a device identifier, operator of the device, current location of the device, current state of the device, current sensor data, current speed of the device, acceleration/deceleration of the device, current ignition status of the device, current fuel level of the device, current battery level of the device, current plugged/unplugged status of the device and duration of time for which no device information is received.

15. The non-transitory computer-readable medium of claim 13, wherein the historical information for one or more IoT devices includes any one or more of: issued alert, location of the device when the alert was issued, time of the day, day of the week, date when the alert was issued, severity of the issued alert, location of the device, routing information for the device, status of the device, state of device over the course of time, sensor reading for the device, duration of time spent by the device at a specific location, speed of the device, acceleration/deceleration of the device, ignition status of the device, fuel level of the device, battery level of the device, plugged/unplugged status of the device, duration of time for which no device information is received, device identifier and operator of the device.

16. The non-transitory computer-readable medium of claim 13, wherein the instructions for correlating the received current device status information with the received historical information for each of the one or more IoT devices further comprise compiling device information for one or more mobile devices based on any one or more of: device identifier, device operator, trip identifier, location coordinates and alert information.

17. The non-transitory computer-readable medium of claim 13, wherein presenting the information in visual format comprises any one or more of a report, a table, a map and color coding the visual representation.

18. The non-transitory computer-readable medium of claim 17, wherein color coding the visual representation is based on criticality of the determined state.
